(19) United States
(12) Patent Application Publication
(10) Pub. No.: US 2023/0095760 A1
(43) Pub. Date: Mar. 30, 2023

(54) ON-VEHICLE RELAY DEVICE, INFORMATION PROCESSING METHOD AND PROGRAM

(71) Applicants: AutoNetworks Technologies, Ltd., Yokkaichi-shi, Mie (JP); Sumitomo Wiring Systems,Ltd., Yokkaichi-shi, Mie (JP); Sumitomo Electric lndustries, Ltd., Osaka-shi, Osaka (JP)

(72) Inventors: Darmawan GO, Yokkaichi-shi, Mie (JP); Hideki MAEDA, Yokkaichi-shi, Mie (JP); Takeshi HAGIHARA, Yokkaichi-shi, Mie (JP); Tatsuya IZUMI, Osaka-shi, Osaka (JP); Ichiro KANDA, Osaka-shi, Osaka (JP)

(21) Appl. No.: 17/907,268

(22) PCT Filed: Mar. 8, 2021
(86) PCT No.: PCT/JP2021/008999

§ 371 Date: Sep. 25, 2022

(30) Foreign Application Priority Data
Mar. 26, 2020 (JP) 2020-056688

(51) Int. Cl. G06F 8/65

(52) U.S. Cl. CPC G06F 8/65; H04L 67/12

(57) ABSTRACT

An on-vehicle relay device comprises a control unit selectively executing a control program stored in a storage or an update processing program, and the control unit specifies, in executing the control program, a first communication unit to which any one of the on-vehicle ECUs as a relay destination is connected with reference to network configuration information stored in a storage, specifying, in executing the update processing program, a second communication unit for communicating with an external device that performs update-related processing of the control program with reference to network configuration information stored in the storage; and prohibiting communication through a communication unit other than the specified communication unit.

### CROSS-REFERENCE TO RELATED APPLICATIONS

This application is the U.S. national stage of PCT/JP2021/008999 filed on Mar. 8, 2021, which claims priority of Japanese Patent Application No. JP 2020-056688 filed on Mar. 26, 2020, the contents of which are incorporated herein.

### TECHNICAL FIELD

The present disclosure relates to an on-vehicle relay device, an information processing method and a program.

A vehicle is mounted with on-vehicle ECUs (Electronic Control Units) that control on-vehicle components for a powertrain system such as engine control and on-vehicle components for a body system such as air conditioning control. An on-vehicle ECU includes an arithmetic processing unit such as an MPU or the like, a rewritable nonvolatile storage such as a RAM or the like and a communication unit for communicating with another on-vehicle ECU, and performs control of the on-vehicle components by reading and executing a control program stored in the storage. Furthermore, the vehicle is mounted with a relay device having a wireless communication function, and thus the vehicle can communicate with a program provision device connected to a network outside the vehicle through the relay device, download (receive) a control program for an on-vehicle ECU from the program provision device and update the control program for this on-vehicle ECU (see Japanese Patent Application Laid-Open No. 2017-97851, for example).

The relay device according to Japanese Patent Application Laid-Open No. 2017-97851 fails to take into consideration the matter related to updating of a control program to be executed in the device itself, and thus it may be possible that the control program of the relay device itself is not efficiently updated.

An object of the present disclosure is to provide an on-vehicle relay device that can efficiently perform an update of a control program of the device itself.

### SUMMARY

An on-vehicle relay device according to one aspect of the present disclosure is an on-vehicle relay device mounted on a vehicle comprises: a plurality of communication units including a first communication unit for communicating with a plurality of on-vehicle ECUs mounted on the vehicle and a second communication unit for communicating with an external device outside the vehicle; a storage storing a control program for performing relay-related control of communications between the plurality of on-vehicle ECUs, an update processing program for performing update-related processing of the control program, and network configuration information related to the plurality of communication units; and a control unit selectively executing the control program or the update processing program that are stored in the storage, wherein in executing the control program, the control unit specifies a first communication unit to which any one of the plurality of on-vehicle ECUs as a relay destination is connected with reference to the network configuration information stored in the storage, and in executing the update processing program, the control unit specifies a second communication unit for communicating with the external device which performs update-related processing of the control program with reference to the network configuration information stored in the storage and prohibits communication using the communication units other than the specified second communication unit for communicating with the external device.

### Effects of the Disclosure

According to one aspect of the present disclosure, it is possible to provide an on-vehicle relay device that can efficiently perform an update of a control program of the device itself.

### BRIEF DESCRIPTION OF DRAWINGS

FIG. 1 is a schematic view illustrating the configuration of an on-vehicle system including an on-vehicle relay device according to Embodiment 1.

FIG. 2 is a block diagram illustrating the configuration of the on-vehicle relay device and the like.

FIG. 3 is an explanatory view illustrating one aspect of network configuration information.

FIG. 4 is a flowchart illustrating processing executed by a control unit of the on-vehicle relay device according to the present embodiment.

### DETAILED DESCRIPTION OF PREFERRED EMBODIMENTS

Embodiments of the present disclosure are first listed and described. At least parts of the embodiments described below may arbitrarily be combined.

The on-vehicle relay device according to an embodiment of the present disclosure is an on-vehicle relay device mounted on a vehicle comprises: a plurality of communication units including a first communication unit for communicating with a plurality of on-vehicle ECUs mounted on the vehicle and a second communication unit for communicating with an external device outside the vehicle; a storage storing a control program for performing relay-related control of communications between the plurality of on-vehicle ECUs, an update processing program for performing update-related processing of the control program, and network configuration information related to the plurality of communication units; and a control unit selectively executing the control program or the update processing program that are stored in the storage, wherein in executing the control program, the control unit specifies a first communication unit to which any one of the plurality of on-vehicle ECUs as a relay destination is connected with reference to the network configuration information stored in the storage, and in executing the update processing program, the control unit specifies a second communication unit for communicating with the external device which performs update-related processing of the control program with reference to the network configuration information stored in the storage and prohibits communication using the communication units other than the specified second communication unit for communicating with the external device.

According to the present aspect, in executing the update processing program, the control unit refers to the network configuration information to be referred at a time of execution of the control program for controlling a relay. That is, the network configuration information related to multiple communication units can be inherited from the control program to the update processing program both of which are selectively executed by the control unit. The control unit executes the update processing program with reference to the network configuration information inherited from the control program. In executing the update processing program, the control unit enables the second communication unit for communicating with the external device that performs the update-related processing while disables or inactivates, for example, the communication units other than the second communication unit for communicating with the external device that performs the update-related processing to prohibit the communications through these communication units. This makes it possible to prevent unauthorized access from the inside and outside of the vehicle through the communication units other than the second communication unit for communicating with the external device that performs the update-related processing and to ensure security and reliability in the update processing of the control program. The control program may thus be updated efficiently.

In the on-vehicle relay device according to a second aspect of the present disclosure, the control unit that is executing the control program writes the network configuration information into a storage area of the storage based on a physical address of the storage, and the control unit that is executing the update processing program refers to the storage area into which the network configuration information is written based on a physical address of the storage.

In the second aspect, the control program and the update processing program are selectively executed by the control unit by being selected by the boot program first executed on startup of the control unit, for example. When the different programs are thus selectively executed by the identical control unit, the logical addresses used when the control unit accesses the storage may be incompatible between the individual programs. Meanwhile, when executing the control program and the update processing program, the control unit, which has a storage area that is accessible from both of the programs in common, accesses this storage area using the physical addresses of the storage determined hardware-wise, not the logical addresses that depend on the respective programs. Accordingly, even if setting (addressing) of the logical address to the storage is different between the control program and the update processing program, the network configuration information can be written by the control program as well as can be referred by the update processing program using the physical addresses of the storage determined hardware-wise. This makes it possible to efficiently inherit or transmit the network configuration information from the control program to the update processing program.

In the on-vehicle relay device according to a third aspect of the present disclosure, the control unit prohibits communication through communication units other than the specified second communication unit for communicating with the external device by stopping supplying power to the communication units.

In the third aspect, when prohibiting communications through the communication units other than the specified second communication unit for communicating with the external device, the control unit stops supplying power to these communication units. This makes it possible to prevent power consumed from execution of the update processing program to update of the control program by these unnecessary communication units and reduce power consumption.

In the on-vehicle relay device according to a fourth aspect of the present disclosure, the external device outside the vehicle includes a diagnostic device connected to the second communication unit and an external server making communication via an out-of-vehicle communication device connected to the second communication unit, the network configuration information includes information in which identifiers for identifying the plurality of communication units are associated with information for making classification among the on-vehicle ECUs, the out-of-vehicle communication device and the diagnostic device that are connected to the plurality of communication units, and the second communication unit for communicating with the external device that performs update-related processing of the control program is the second communication unit to which the diagnostic device or the out-of-vehicle communication device is connected.

In the fourth aspect, the network configuration information includes information in which identifiers of the communication units such as a physical port number, for example, are associated with information such as IP address or MAC address, for example, for making classification among the external device (the diagnostic device and the out-of vehicle communication device for connecting to the external server) and the on-vehicle ECUs that are connected to the communication units. In such network configuration information, the second communication unit for communicating with the external device that performs the update-related processing is regarded as the second communication unit connected to the diagnostic device or the out-of-vehicle communication device, whereby the control unit which is executing the update processing program can easily specify the second communication unit for communicating with the external device that performs the update-related processing and can efficiently prohibit communications with the communication units other than the second communication unit connected to the diagnostic device or the out-of-vehicle communication device.

In the on-vehicle relay device according to a fifth aspect of the present disclosure, the external device outside the vehicle includes a diagnostic device connected to the second communication unit and an external server making communication via an out-of-vehicle communication device connected to the second communication unit, the network configuration information includes information in which identifiers for identifying the plurality of communication units are associated with information for making classification among the on-vehicle ECUs, the out-of-vehicle communication device and the diagnostic device that are connected to the plurality of communication units, the control unit that is executing the control program, if obtaining update-related information output from the diagnostic device, incorporates in the network configuration information a matter that the second communication unit for communicating with the external device that performs update-related processing of the control program is the second communication unit to which the diagnostic device is connected, and if obtaining update-related information output from the external server, incorporates in the network configuration information a matter that the second communication unit for communicating with the external device that performs update-related processing of the control program is the second communication unit to which the out-of-vehicle communication device is connected.

In the fifth aspect, the control unit which is executing the control program incorporates in the network configuration information a matter that based on information about an output destination of the update-related information, the communication unit connected to the output destination is the second communication unit for communicating with the external device that performs update-related processing. Accordingly, the control unit which is executing the update processing program can easily specify the second communication unit for communicating with the external device that performs the update-related processing by referring to the network configuration information inherited from the control program and can efficiently prohibit communications through the communication units other than the second communication unit connected to the diagnostic device.

An information processing method according to an embodiment of the present disclosure causes a computer to execute processing of: selectively executing relay-related control of communications between a plurality of on-vehicle ECUs or update-related processing of a program for performing the relay-related control; specifying, in executing the relay-related control, a communication unit to which any one of the on-vehicle ECUs as a relay destination is connected with reference to network configuration information stored in a storage; specifying, in executing the update-related processing, a communication unit for communicating with an external device that performs update-related processing with reference to network configuration information stored in the storage; and prohibiting communication through a communication unit other than the communication unit specified.

In the present aspect, an information processing method that causes the computer to efficiently perform an update of a control program of the on-vehicle relay device can be provided.

A program according to an embodiment of the present disclosure causes a computer to execute processing of selectively executing relay-related control of communications between a plurality of on-vehicle ECUs or update-related processing of a program for performing the relay-related control; specifying, in executing the relay-related control, a communication unit to which any one of the on-vehicle ECUs as a relay destination is connected with reference to network configuration information stored in a storage; specifying, in executing the update-related processing, a communication unit for communicating with an external device that performs update-related processing with reference to network configuration information stored in the storage; and prohibiting communication through a communication unit other than the communication unit specified.

In the present aspect, a computer can be used as an on-vehicle relay device that efficiently performs an update of a control program of the device itself.

Concrete examples of an on-vehicle relay device 2 according to embodiments of the present disclosure will be described below with reference to the drawings. The scope of the present disclosure is indicated not by the meaning described above but by the claims, and all changes that fall within the meaning equivalent to the claims and the scope are to be embraced.

### Embodiment 1

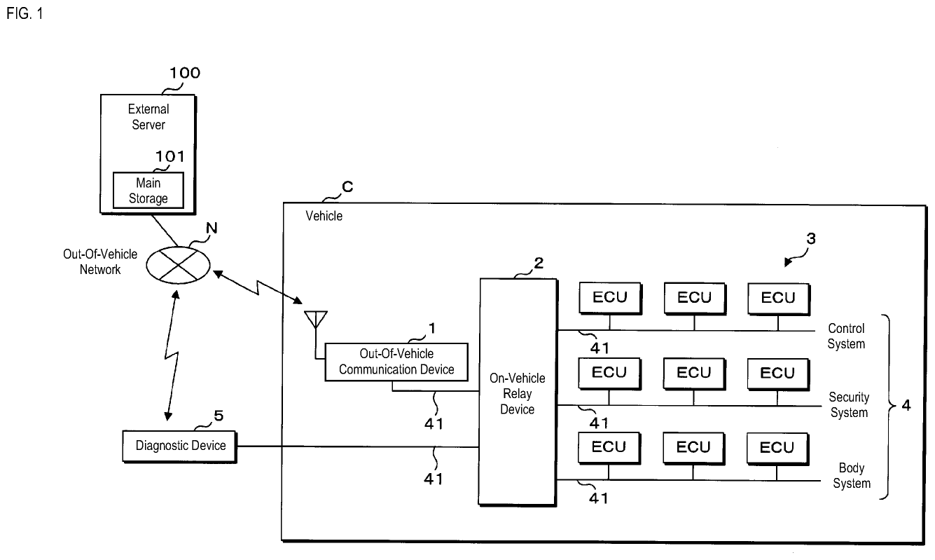

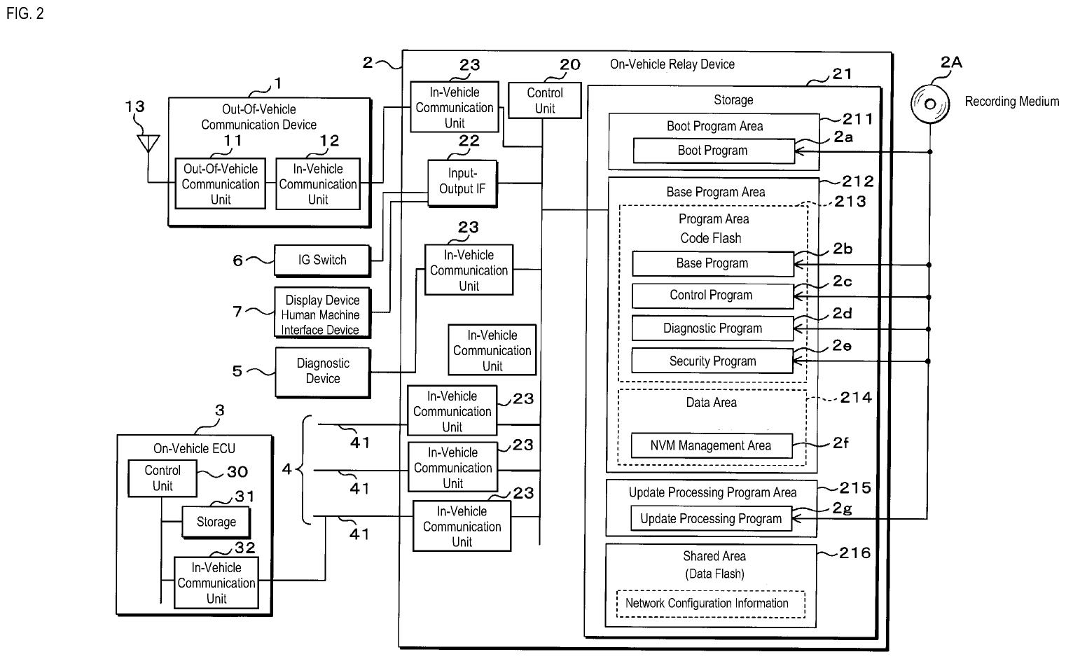

The present disclosure will be described in details below based on the drawings showing embodiments thereof. FIG. 1 is a schematic view illustrating the configuration of an on-vehicle system including an on-vehicle relay device 2 according to Embodiment 1. FIG. 2 is a block diagram illustrating the configuration of the on-vehicle relay device 2 and the like. The on-vehicle system includes an out-of-vehicle communication device 1 and the on-vehicle relay device 2 that are mounted on a vehicle C, and the on-vehicle relay device 2 communicates with an external server 100 via the out-of-vehicle communication device 1. The on-vehicle relay device 2 communicates with a diagnostic device 5 that is directly connected to the device itself.

The external server 100 and the diagnostic device 5 correspond to external devices that perform update-related processing of a control program 2c of the on-vehicle relay device 2. By obtaining an update program from the external server 100 and the diagnostic device 5, the on-vehicle relay device 2 executes reprogramming through an update of the control program 2c to be executed in the device itself, that is, application of the obtained update program as a new version program for the control program 2c.

The external server 100 is a computer such as a server or the like that is connected to an out-of-vehicle network N, for example, the Internet or a public network and has a storage 101 formed of a RAM (Random Access Memory), a ROM (Read Only Memory), a hard disk or the like. The storage 101 stores a program or data for controlling the on-vehicle relay device 2 created by the manufacturer or the like of the on-vehicle relay device 2. The program or the data is transmitted to the vehicle C as an update program to be described later and used for updating the control program 2c or the data of the on-vehicle relay device 2 mounted on the vehicle C. The external server 100 thus configured is also referred to as an Over The Air (OTA) server. By obtaining such an update program wirelessly transmitted from the external server 100 and by applying the update program to the control program 2c to be executed, the on-vehicle relay device 2 mounted on the vehicle C can update (reprogram) the control program 2c to be executed by the device itself. The external server 100 may have stored a program or data of the on-vehicle ECU 3 connected to the on-vehicle relay device 2 other than the control program 2c of the on-vehicle relay device 2. The on-vehicle relay device 2 may function as a reprogramming master that obtains a program or the like of the on-vehicle ECU 3 connected to the device itself from the external server 100, outputs (transmits) the obtained program or the like to the on-vehicle ECU 3 as a subject to be updated (subject to be reprogrammed) and performs update processing (reprogramming processing) of the program of this on-vehicle ECU 3.

The diagnostic device 5 is a device (diagnostic tool) used by a vehicle maintenance shop including a legitimate dealer who is in charge of performing maintenance of the vehicle C such as maintenance work for the on-vehicle relay device 2 or the on-vehicle ECU 3. The diagnostic device 5 is a device formed of a general-purpose information terminal, such as a personal computer, a tablet PC, a smartphone or the like that is installed with a dedicated application or a device configured as a special purpose information terminal including a hardware. The diagnostic device 5 includes a control unit (not illustrated) formed of a CPU or an MPU, a storage (not illustrated) and an in-vehicle communication unit 23 (not illustrated) as in the on-vehicle ECU to be described later. The diagnostic device 5 communicates with the on-vehicle relay device 2 via the in-vehicle communication unit 23. The storage of the diagnostic device 5 has stored a program or data for controlling the on-vehicle relay device 2 as in the external server 100. The program or data stored in the diagnostic device 5 is transmitted to the vehicle C as an update program so as to be used for updating the control program 2c or data of the on-vehicle relay device 2 mounted on the vehicle C as in the external server 100.

The vehicle C is mounted with the out-of-vehicle communication device 1, the on-vehicle relay device 2, a display device 7 and multiple on-vehicle ECUs 3 for controlling various on-vehicle components. The out-of-vehicle communication device 1 is communicably connected to the on-vehicle relay device 2 through a communication line 41 (Ethernet cable) or the like in compliance with a communication protocol such as Ethernet (registered trademark), for example. The on-vehicle relay device 2 is communicably connected to the on-vehicle ECUs 3 through communication lines 41 in compliance with a communication protocol such as Ethernet or the like and an in-vehicle LAN 4. The connection between the on-vehicle relay device 2 and the on-vehicle ECUs 3 may be performed through a CAN bus in compliance with the CAN (Control Area Network/registered trademark), for example, not limited to be performed through Ethernet.

The out-of-vehicle communication device 1 includes an out-of-vehicle communication unit 11 and an in-vehicle communication unit 12. The in-vehicle communication unit 12 is an Ethernet PHY unit in compliance with a TCP/IP packet transmitted through a communication line 41 including an Ethernet cable such as 100BASE-T1 or 1000BASE-T1, for example. The out-of-vehicle communication device 1 is communicably connected to the on-vehicle relay device 2 via the in-vehicle communication unit 12 and a communication line 41 such as an Ethernet cable or the like.

The out-of-vehicle communication unit 11 is a communication device for performing wireless communication using a protocol for mobile communications such as 3G, LTE, 4G, 5G, WiFi or the like, and transmits and receives data to/from the external server 100 via an antenna 13 connected to the out-of-vehicle communication unit 11. The communication between the out-of-vehicle communication device 1 and the external server 100 is performed via an out-of-vehicle network N, for example, a public network or the Internet.

Though the out-of-vehicle communication device 1 is configured to be provided separately from the on-vehicle relay device 2 and these devices are communicably connected via the in-vehicle communication unit 12 or the like in the present embodiment, the configuration is not limited to such a separated configuration. The out-of-vehicle communication device 1 may be configured so as to be incorporated in the on-vehicle relay device 2 as one component of the on-vehicle relay device 2.

As illustrated in FIG. 2, the on-vehicle relay device 2 includes a control unit 20, a storage 21, an input-output I/F 22, an in-vehicle communication unit 23 and the like. The on-vehicle relay device 2 supervises segments of the systems, with multiple communication lines 41, including on-vehicle ECUs 3 for a control system, on-vehicle ECUs 3 for a security system and on-vehicle ECUs 3 for a body system, and relays communications between the on-vehicle ECUs 3 among these segments. The on-vehicle relay device 2 is a gateway or an Ethernet switch, for example, and may function as a layer 2 switch, a layer 3 switch and a CAN gateway. The on-vehicle relay device 2 may be configured as one operation part such as a body ECU for controlling the entire vehicle C, an automatic driving ECU for controlling automatic driving or the like. The on-vehicle relay device 2 may be a Power Lan Box (PLB) functioning as a power distribution device for distributing and relaying power output from a storage battery (not illustrated) and supplying the power to the on-vehicle ECUs 3 connected to the device itself in addition to relaying communications.

The control unit 20 is composed of a CPU (Central Processing Unit), an MPU (Micro Processing Unit) or the like. The control unit 20 performs various kinds of control processing, arithmetic processing or the like by reading and executing programs and data previously stored in the storage 21. Note that the wording “program” may include a program and data necessary for executing the program.

The storage 21 is composed of a volatile memory device such as a RAM (Random Access Memory) or the like, or a nonvolatile memory device such as a ROM (Read Only Memory), an EEPROM (Electrically Erasable Programmable ROM), a flash memory or the like. The storage 21 includes a boot program area 211, a base program area 212, an update processing program area 215 and a shared area 216. That is, the storage 21 is segmented into storage areas including the boot program area 211, the base program area 212, the update processing program area 215 and the shared area 216.

The boot program area 211 stores a boot program 2a. The boot program 2a is a program such as a bootloader or the like that is first launched after resetting or upon startup of the on-vehicle relay device 2. By executing the boot program 2a, the control unit 20 performs processing of selectively launching either of a base program 2b or an update processing program 2g depending on the information on the presence or absence of an update stored in the shared area 216.

The information on the presence or absence of an update may be indicated by, for example, the presence or absence of an update flag stored in a block of a predetermined physical address in the shared area 216, i.e., an identifier (bit value) of 0 or 1 stored in the block. If the update flag is present (identifier=1), the control unit 20 launches the update processing program 2g. If the update flag is absent (identifier=0), the control unit 20 launches the base program 2b. The boot program 2a may be configured to be terminated after execution of the processing of launching the update processing program 2g or the base program 2b.

In the update processing program area 215, the update processing program 2g is stored. The update processing program 2g is, in the case where an update program is output or transmitted and offered from the external server 100 or the diagnostic device, a program (software for reprogramming) for executing update processing of updating the control program 2c as a subject to be updated to the update program. By executing the update processing program 2g, the control unit 20 performs update processing of obtaining an update program from an external device such as the out-of-vehicle communication device 1, the diagnostic device 5 or the like through communication with the external device and storing the obtained update program in the base program area 212. After termination of the update processing, the control unit 20 may be configured to delete the update flag in the shared area 216 and store an identifier indicating the termination of the update processing in the shared area 216. Although the details will be described later, by executing the update processing program 2g, the control unit 20 performs processing of specifying an in-vehicle communication unit 23 for communicating with the external device that performs the update-related processing with reference to the network configuration information stored in the shared area 216 and of disabling the in-vehicle communication units 23 other than the specified in-vehicle communication unit 23.

The base program area 212 includes a program (code flash) area 213 and a data (data flash) area 214. In the program area 213, the base program 2b and the control program 2c, a diagnostic program 2d and a security program 2e that are to be executed on the base program 2b are stored. In the data area 214, an NVM management area 2f to be managed by an input-output function (NVM) included in the base program 2b is included. The base program 2b is a so-called operating system and may comply with the standards, for example, Linux (registered trademark) or Automotive Open System Architecture (AUTOSAR).

The control program 2c, the diagnostic program 2d and the security program 2e are all programs to be executed using the base program 2b as a platform.

The control program 2c is a program executed in a state where the update processing based on the update processing program 2g is not executed and performs relaying of communications between the on-vehicle ECUs 3 or communications between the external server 100 and the on-vehicle ECU 3. The control program 2c is a subject to be updated by the update program transmitted from the on-vehicle relay device 2. By executing the control program 2c, the control unit 20 relays, for example, an IP packet, a CAN message and the like transmitted from the on-vehicle ECU 3 with reference to the network configuration information stored in the storage 21. Though the details will be described later, the network configuration information includes relay route information (a routing table) for relaying an IP packet or the like between the in-vehicle communication units 23 and information for specifying which one of the in-vehicle communication units 23 is a communication unit for communication with the external device that performs update-related processing.

The diagnostic program 2d is configured as one module included in the control program 2c and is a program to be executed as a sub process for the process of the control program 2c. That is, the diagnostic program 2d is to be executed as one function of the control program 2c and monitors the presence or absence of the information related to the update program. By executing the diagnostic program 2d, the control unit 20 periodically makes an inquiry about the presence or absence of update-related information of the control program 2c mounted on the vehicle C through communication with the external server 100 using the out-of-vehicle communication device 1. If the update-related information is present, by holding, i.e. writing an identifier (update flag) indicating the presence of an update request into the shared area 216, the control unit 20 stores the identifier in the storage 21.

The diagnostic program 2d is not limited to a program to be executed as a sub process for the process of the control program 2c.

For example, the diagnostic program 2d is a program executed in parallel with the control program 2c and monitors the presence or absence of information related to the update program. In the present embodiment, assuming that the control program 2c is synonymous with the diagnostic program 2d in the processing performed on the information of the update program, the update program will be described as a function of the control program 2c in the description below.

If communicating with the external device such as the diagnostic device 5 or the external server 100 that performs update-related processing and obtaining the update-related information from the external device, by executing the control program 2c, the control unit 20 holds (writes, stores) an identifier (update flag) indicating the presence of an update request in the shared area 216. Moreover, the control unit 20 holds in the shared area 216 the network configuration information together with the identifier indicating the presence of an update request. Alternatively, the control unit 20 which is executing the control program 2c may be configured to hold the network configuration information instead of the identifier indicating the presence of an update request in the shared area 216. That is, the control unit 20 may be configured to perform processing regarding holding of the network configuration information in the shared area 216 as the presence of an update request.

The security program 2e is a program executed in parallel with the control program 2c and the diagnostic program 2d and manages security information for the control program 2c and the diagnostic program 2d.

The above-described boot program 2a, base program 2b, control program 2c, diagnostic program 2d, security program 2e and update processing program 2g that are stored in the storage 21 may be the ones having been read from the recording medium 2A which is readable by the on-vehicle relay device 2 and stored. Alternatively, the boot program 2a, the base program 2b, the control program 2c, the diagnostic program 2d, the security program 2e and the update processing program 2g may be the ones having been downloaded from an external computer (not illustrated) connected to a communication network (not illustrated) and stored in the storage 21. Moreover, the storage 21 may be configured to store the vehicle configuration information of all the on-vehicle ECUs 3 mounted on the on-vehicle relay device 2 and the vehicle C. The vehicle configuration information may include a Vehicle Identification Number (VIN) of the vehicle C, models of the on-vehicle relay device 2 and the on-vehicle ECUs 3, the name and the version number of the packaged programs and the like.

Though the above description is made assuming that the control program 2c, the diagnostic program 2d and the security program 2e that are executed on the base program 2b are configured to be different program modules, the configuration of these programs is not limited thereto. For example, the control program 2c, the diagnostic program 2d and the security program 2e may be configured so as to be included in the base program 2b as parts of the functions of the base program 2b.

The NVM management area 2f is a data storage area managed by an input-output function (memory management function) included in the base program 2b. The control unit 20 which is executing the base program 2b stores data in the NVM management area 2f using the input-output function for translating logical addresses to physical addresses in the normal processing based on the base program 2b. That is, the control unit 20 which is executing the base program 2b stores translation information for performing translation by associating a logical address with a physical address by the input-output function and stores the data in the NVM management area 2f specified with reference to the translation information. Accordingly, the NVM management area 2f is inaccessible from the control unit 20 which is executing a program other than the base program 2b not provided with the input-output function. That is, if executing the boot program 2a and the update processing program 2g, the control unit 20 cannot refer to the information stored in the NVM management area 2f. By performing the input-output processing on the NVM management area 2f thus configured using the input-output function included in the base program 2b, the control unit 20 reads and writes data, a program or the like from/into the NVM management area 2f.

The shared area 216 is an area for storing an identifier indicating the information on the presence or absence of an update and the network configuration information and is an area used for inheriting the identifier and the network configuration information from the control program 2c to the update processing program. The shared area 216 is a data storage area that is not managed by the input-output function included in the base program 2b and is a data storage area where the location can be uniquely designated by using the physical address. The control unit 20 which is executing the input-output function included in the base program 2b cannot access the shared area 216. If recognizing the information on the presence or absence of an update, the control unit 20 which is executing the diagnostic program 2d and the control program 2c stores the identifier and the network configuration information in the shared area 216. In this case, the control unit 20 designates the shared area 216 using the physical address being the physical location information in the nonvolatile memory of the storage 21 and stores the identifier and the network configuration information in the shared area 216. That is, the control unit 20 stores the identifier in the shared area 216 by directly designating the physical address without performing the translation processing of associating the logical address with the physical address by the function of the base program 2b. Thus, even the control unit 20 which is executing the processing based on the boot program 2a can recognize the identifier indicating the information on the presence or absence of an update with reference to the shared area 216 where the location is designated without launching the base program 2b. Moreover, even the control unit 20 which is executing the processing based on the update processing program can recognize the network configuration information with reference to the shared area 216 where the location is designated without launching the base program 2b.

The input-output I/F 22 is a communication interface for performing a serial communication, for example. The on-vehicle relay device 2 is communicably connected to the display device 7 such as a display or the like and an IG switch 6 for starting and stopping of the vehicle via the input-output I/F 22.

The in-vehicle communication unit 23 is an input-output interface using a communication protocol such as Ethernet, CAN or the like. The control unit 20 mutually communicates with the on-vehicle ECUs 3 connected to the in-vehicle LAN 4, the out-of-vehicle communication device 1 and other on-vehicle components such as a relay device or the diagnostic device 5 via the in-vehicle communication units 23.

More than one in-vehicle communication units 23 are provided and respectively connected with the communication lines 41 constituting the in-vehicle LAN 4. By thus providing multiple in-vehicle communication units 23, the in-vehicle LAN 4 may be divided into segments, each segment being connected to the on-vehicle ECUs depending on the function (control-based function, security-based function or body-based function) of each on-vehicle ECU.

Some of the in-vehicle communication units 23 are also connected to the diagnostic device 5 and the out-of-vehicle communication device 1 for communicating with the external server, and communication with the external device such as the diagnostic device 5 and the external server is made possible via the in-vehicle communication units 23. That is, the in-vehicle communication unit 23 to which the diagnostic device 5 or the out-of-vehicle communication device 1 is connected corresponds to a communication unit for communicating with the external device that performs the update-related processing.

The on-vehicle ECU 3 includes a control unit 30, a storage 31 and an in-vehicle communication unit 32. The storage 31 is composed of a volatile memory device such as a RAM (Random Access Memory) or the like, or a nonvolatile memory device such as ROM (Read Only Memory), EEPROM (Electrically Erasable Programmable ROM), a flash memory or the like and stores a program or data for the on-vehicle ECU 3. The control unit 30 is composed of a CPU (Central Processing Unit) or an MPU (Micro Processing Unit) or the like and performs control processing or the like by reading and executing the program and data stored in the storage 31 to control the on-vehicle components including this on-vehicle ECU 3, an actuator or the like.

The input output I/F 22 of the on-vehicle relay device 2 is communicably connected to the IG switch 6 (ignition switch) for starting or stopping of the vehicle C by a wire harness such as a serial cable or the like. In the case where the IG switch 6 is turned on or off, the control unit 20 of the on-vehicle relay device 2 obtains (receives) a signal output (transmitted) from the IG switch 6 via the input/output I/F 22.

The display device 7 is a Human Machine Interface (HMI) device such as a display of a car navigation or the like. The display device 7 is communicably connected to the input/output I/F 22 of the on-vehicle relay device 2 by a harness such as a serial cable or the like. The display device 7 displays data or information output from the control unit 20 of the on-vehicle relay device 2 via the input/output I/F 22.

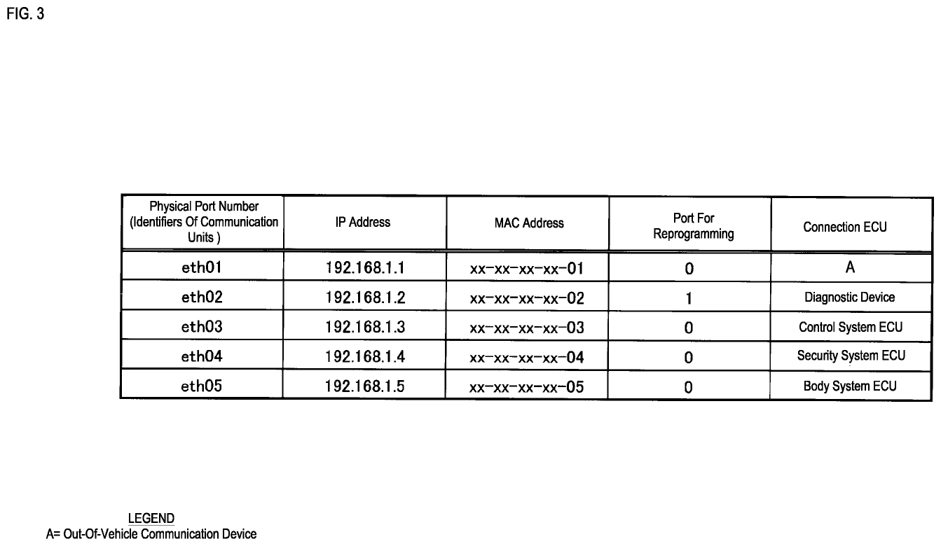

FIG. 3 is an explanatory view illustrating one aspect of network configuration information. As described above, the network configuration information is stored in the storage 21 of the on-vehicle relay device 2. The network configuration information is stored in the shared area 216 of the storage 21 that is accessible by the control unit 20 which is executing the update processing program 2g and by the control unit 20 which is executing the control program 2c (diagnostic program 2d), i.e., by the control units 20 which are executing any of the programs. Alternatively, when controlling the relay of the communications between the on-vehicle ECUs 3 based on the control program 2c, the control unit 20 refers to the network configuration information stored in the area managed according to the logical address set by the base program 2b such as NVM management area 2f, for example. Then, in the case where the control unit 20 which is executing the control program 2c obtains the update-related information from the diagnostic device 5 or the external server 100, it may write by copying the network configuration information stored in the NVM management area 2f or the like into the shared area 216.

When writing by copying the network configuration information stored in the NVM management area 2f or the like into the shared area 216, the control unit 20 which is executing the control program 2c does not necessarily write all the information included in the network configuration information. When writing into the shared area 216 the network configuration information stored in the NVM management area 2f or the like by copying, the control unit 20 which is executing the control program 2c may write into the shared area 216 at least information for specifying the in-vehicle communication unit 23 for communicating with the external device which executes the update-related processing of the information included in the network configuration information.

The network configuration information is stored in a tabular form, for example, and includes a physical port number, an IP address, an MAC (Media Access Control) address, a port for reprogramming and a connection ECU as control items (field) of the in-vehicle communication unit 23.

In the physical port number field of the in-vehicle communication unit 23, physical port numbers such as serial numbers or the like assigned so as not to be duplicated between the individual in-vehicle communication units 23 are stored. In the case where the in-vehicle communication unit 23 is an Ethernet PHY unit, a device number indicating this Ethernet PHY unit may be stored in this physical port number field.

In the IP address field, IP addresses (addresses corresponding to a network layer when communication using TCP/IP is made) of the on-vehicle ECU3, the out-of-vehicle communication device 1 or the diagnostic device 5 that is connected to the in-vehicle communication unit 23 of the corresponding physical port number are stored. The control unit 20 functions as a layer 3 switch by referring to the IP address.

In the MAC address field, MAC addresses (addresses corresponding to a data link layer when communication using Ethernet is made) of the on-vehicle ECU 3, the out-of-vehicle communication device 1 or the diagnostic device 5 that is connected to the in-vehicle communication unit 23 of the corresponding physical port number are stored. The control unit 20 functions as a layer 2 switch by referring to the MAC address.

In the reprogramming port field, identifiers (flags) for specifying the in-vehicle communication unit 23 for communicating with the external device that performs the update-related processing of the control program 2c of the on-vehicle relay device 2 are stored. In the present embodiment, 1 is set as an identifier for specifying the in-vehicle communication unit 23 for communicating with the external device that performs the update-related processing, and as illustrated in the drawing, the physical port of eth02 (reprogramming-specific port: 1) is specified as the in-vehicle communication unit 23 for communicating with this external device. That is, the other physical ports for which 0, not 1, is held in the reprogramming port field are specified as the in-vehicle communication units 23 other than the in-vehicle communication unit 23 for communicating with the external device that performs the update-related processing. Since the network configuration information thus includes information for specifying which one of the in-vehicle communication units 23 is for communicating with the external device that performs the update-related processing for each of the in-vehicle communication units 23 included in the on-vehicle relay device 2, the control unit 20 which is executing the update processing program 2g can easily specify the in-vehicle communication unit 23 for communicating with the external device.

In the connection ECU field, the information on the names, types or grouping of the on-vehicle devices to be connected to the in-vehicle communication unit 23 of the corresponding physical port number are stored.

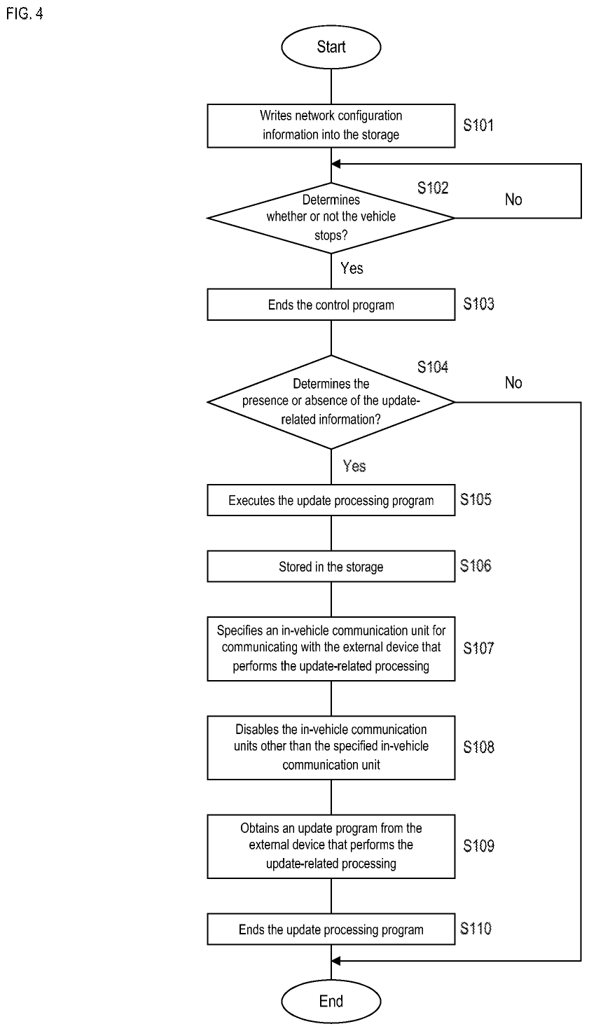

FIG. 4 is a flowchart illustrating processing executed by the control unit 20 of the on-vehicle relay device 2 according to the present embodiment. The control unit 20 of the on-vehicle relay device 2 routinely performs the following processing in a state where the vehicle C is in a start state (the IG switch 6 is turned on) or in a stopped state (the IG switch 6 is turned off), for example.

The control unit 20 of the on-vehicle relay device 2 writes network configuration information into the storage 21 (shared area 216) (S101). When performing this processing, the control unit 20 which is executing the control program 2c for relaying communications between the on-vehicle ECUs 3 may be configured to write the network configuration information into the shared area 216 based on the physical address of the shared area 216 of the storage 21 by using the input-output function of the control program 2c. Alternatively, by executing the base program 2b and further executing the control program 2c and the diagnostic program 2d on the base program 2b in parallel, the control unit 20 may be configured to write the network configuration information into the shared area 216 based on the physical address of the shared area 216 by using the input-output function of the diagnostic program 2d.

Since the shared area 216 into which the network configuration information is to be written is an area specified based on the physical address of the storage 21, the control unit 20 can access the shared area 216 regardless of the program it executes, whether the control program 2c or the update processing program 2g. Accordingly, by using the shared area 216, the network configuration information can reliably be inherited from the control program 2c to the update processing program 2g.

When writing the network configuration information into the storage 21 (shared area 216), the control unit 20 may also be configured to write the update-related information (campaign information) obtained from the external device into the shared area 216. If the on-vehicle relay device 2 is connected to the external device such as the diagnostic device 5, the external server 100 or the like and receives the update-related information transmitted (output) from such an external device, the control unit 20 may be configured to write the network configuration information into the storage 21 (shared area 216). In this case, the control unit 20 may be configured to reflect the information for specifying the in-vehicle communication unit 23 used for communicating with the external device having transmitted (output) the update-related information on the network configuration information and to write this network configuration information into the storage 21 (shared area 216).

In the case where the external device having transmitted (output) the update-related information is the diagnostic device 5, the control unit 20 changes the flag stored in the reprogramming port field for the in-vehicle communication unit 23 that is connected to the diagnostic device 5 to 1 and changes the flags stored in the reprogramming port field for the other in-vehicle communication units 23 to 0 in the network configuration information to thereby specify the in-vehicle communication unit 23 used for communicating with the external device. Alternatively, in the case where the external device having transmitted (output) the update-related information is the external server 100, the control unit 20 changes the flag stored in the reprogramming port field for the in-vehicle communication unit 23 that is connected to the external server 100 to 1 and changes the flags stored in the reprogramming port field for the other in-vehicle communication units 23 to 0 in the network configuration information to thereby specify the in-vehicle communication unit 23 used for communicating with the external device.

The network configuration information is thus changed based on the external device having transmitted (output) the update-related information, so that even if there are one or more in-vehicle communication units 23 used for communicating with the external device that performs the update-related processing, the in-vehicle communication unit 23 used in the processing related to the current update can easily be specified. Accordingly, the in-vehicle communication units 23 unnecessary for the update-related processing are reliably disabled and prohibited to communicate, which ensures security for the update-related processing.

The control unit 20 does not necessarily write all the information included in the network configuration information into the shared area 216. The control unit 20 may be configured to write into the shared area 216 information for specifying the in-vehicle communication unit 23 such as a physical port number or the like of the in-vehicle communication unit 23 for communicating with the external device that performs the update-related processing in the network configuration information. Alternatively, the control unit 20 may be configured to write into the shared area 216 physical port numbers or the like of the in-vehicle communication units 23 other than in-vehicle communication unit 23 for communicating with the external device that performs the update-related processing, that is, the physical port numbers of the in-vehicle communication units 23 to be disabled in the processing described later.

The control unit 20 of the on-vehicle relay device 2 determines whether or not the vehicle C stops (S102). If the vehicle C does not stop (S102: NO), the control unit 20 of the on-vehicle relay device 2 performs loop processing in order to execute the processing at S102 again. If the vehicle C stops (S102: YES), the control unit 20 of the on-vehicle relay device 2 ends the control program 2c (S103). In the present embodiment, when the control program 2c that is being executed by the control unit 20 of the on-vehicle relay device 2 is to be ended, that is, when the on-vehicle relay device 2 is to be reset, stopping of the vehicle C (turning off of the IG switch 6) is used as a trigger, but any event can be used as a trigger. The end of the control program 2c may be performed based on a reset signal or the like output from the external device such as the diagnostic device 5, for example.

The control unit 20 of the on-vehicle relay device 2 determines the presence or absence of the update-related information (S104). The control unit 20 executes the boot program 2a, for example, and determines the presence or absence of the update-related information with reference to the storage 21 (shared area 216) by using the input-output function included in the boot program 2a.

If the update-related information is absent (S104: NO), the control unit 20 of the on-vehicle relay device 2 ends a series of processing according to the present embodiment. If the update-related information is absent, that is, if the information (campaign information) related to an update of the control program 2c of the on-vehicle relay device 2 is not obtained from the external device that performs the update-related processing such as the diagnostic device 5 or the like, the control unit 20 ends the series of processing in the present embodiment and shifts to, for example, a stopped state or a standby (sleep) state in response to a stopped state of the vehicle C.

If the update-related information is present (S104: YES), the control unit 20 of the on-vehicle relay device 2 executes the update processing program 2g (S105). If the update-related information is present, that is, if the update-related information (campaign information) of the control program 2c of the on-vehicle relay device 2 is obtained from the external device that performs the update-related processing such as the diagnostic device 5 or the like, the control unit 20 executes the update processing program 2g.

The case where the control unit 20 determines that the update-related information is present is not limited to the case where the update-related information (campaign information) of the control program 2c of the on-vehicle relay device 2 is stored in the storage 21 (shared area 216). The control unit 20 may be configured to determine that the update-related information is present in response to the network configuration information being stored in the storage 21 (shared area 216). That is, regarding the network configuration information as a correspondence to the update-related information, the control unit 20 of the on-vehicle relay device 2 may determine the presence or absence of the update-related information.

The control unit 20 of the on-vehicle relay device 2 refers to the network configuration information stored in the storage 21 (shared area 216) (S106). The control unit 20 which is executing the update processing program 2g accesses the storage 21 (shared area 216) by using the physical address, for example, and refers to the network configuration information stored in the shared area 216.

The control unit 20 of the on-vehicle relay device 2 specifies an in-vehicle communication unit 23 for communicating with the external device that performs the update-related processing (S107). The control unit 20 which is executing the update processing program 2g specifies an in-vehicle communication unit 23 for communicating with the external device that performs the update-related processing by referring to the flag information for each of the in-vehicle communication units 23 stored in the reprogramming port field included in the network configuration information, for example. Alternatively, the update-related information (campaign information) obtained from the external device includes the physical port number of the in-vehicle communication unit 23 used for communicating with this external device. The control unit 20 may be configured to specify an in-vehicle communication unit 23 for communicating with the external device that performs the update-related processing based on the physical port number. Alternatively, the update-related information (campaign information) obtained from the external device includes the address (IP address, MAC address) of this external device, and the control unit 20 specifies the in-vehicle communication unit 23 corresponding to this address as the in-vehicle communication unit 23 for communicating with the external device that performs the update-related processing.

The control unit 20 of the on-vehicle relay device 2 disables the in-vehicle communication units 23 other than the specified in-vehicle communication unit 23 (S108). The control unit 20 which is executing the update processing program 2g disables the in-vehicle communication units 23 other than the in-vehicle communication unit 23 for communicating with the external device that performs the update-related processing by outputting an off signal, for example, to these in-vehicle communication units 23 to prohibit relaying through the in-vehicle communication units 23.

The control unit 20 may be configured to prohibit relaying through these in-vehicle communication units 23 by stopping supplying power to the in-vehicle communication units 23 other than the in-vehicle communication unit 23 for communicating with the external device that performs the update-related processing. That is, the control unit 20 may stop supplying power to these in-vehicle communication units 23 by turning off switches provided on power lines connected to these in-vehicle communication units 23, for example.

The control unit 20 of the on-vehicle relay device 2 obtains an update program from the external device that performs the update-related processing (S109). The update program obtained from the external device corresponds to a new version program for the control program 2c that has been executed in the on-vehicle relay device 2 until now. The control unit 20 obtains (receives) the update program from the external device such as a diagnostic device 5 or the like, writes the obtained update program in the program area 213 (code flash) of the storage 21 as a control program 2c to be executed from the next booting and stores it in the storage 21.

The control unit 20 of the on-vehicle relay device 2 ends the update processing program 2g (S110). When ending the update processing program 2g, the control unit 20 is configured to delete the network configuration information and the update-related information (campaign information) of the control program 2c of the on-vehicle relay device 2 stored in the storage 21 (shared area 216). The control unit 20 ends the update processing program 2g and shifts to the stopped state or the standby (sleep) state, for example, in response to the vehicle C being in the stopped state.

By deleting the network configuration information and the update-related information from storage 21 (shared area 216), the control unit 20 of the on-vehicle relay device 2 determines that the update-related information is absent, that is, that updating of the control program 2c of the on-vehicle relay device 2 is not necessary at a time when the vehicle C is activated next. Thus, the control unit 20 of the on-vehicle relay device 2 employs the update program obtained in the processing at S109 to execute the new version of the control program 2c. By executing the new version of the control program 2c, the on-vehicle relay device 2 functions as a gateway or an Ethernet switch that performs relay processing between the on-vehicle ECUs 3. When executing the control program 2c, the control unit 20 may be configured to first execute the base program 2b and then execute the control program 2c on the base program 2b.

According to the present embodiment, the control unit 20 which is executing the update processing program 2g refers to the network configuration information inherited from the control program 2c. Since the network configuration information inherited from the control program 2c includes information for specifying an in-vehicle communication unit 23 for communicating with the external device that performs the update-related processing, the control unit 20 which is executing the update processing program 2g can easily specify the in-vehicle communication unit 23 to be used in the update-related processing.

The control unit 20 which is executing the update processing program 2g enables the in-vehicle communication unit 23 for communicating with the external device that performs the update-related processing and disables or inactivates the in-vehicle communication units 23 other than the in-vehicle communication unit 23 for communicating with the external device that performs the update-related processing to prohibit the communications through these in-vehicle communication units 23. In the update (reprogramming) processing for the control program 2c of the relay device itself, the on-vehicle relay device 2 may prevent an unauthorized access through an unnecessary in-vehicle communication unit 23, and may thus ensure the security and reliability of the control program 2c in the update processing. The control program 2c may therefore be updated efficiently.

According to the present embodiment, in executing both of the control program 2c and the update processing program 2g, the control unit 20 accesses the shared region 216 using the physical address, for example, to write and refer to the network configuration information. Accordingly, in the case of selectively executing one of the control program 2c and the update processing program 2g by the same control unit 20, even if the logical address used to access the storage 21 is not compatible, the shared region 216 which is accessible by both of the programs may be used so as to inherit the network configuration information used in the control program 2c to the update processing program 2g.

According to the present embodiment, the control unit 20 which is executing the control program 2c changes the value (flag) stored in the reprogramming port field included in the network configuration information based on the output destination of update-related information, and reflects the information specifying the in-vehicle communication unit 23 for communicating with the external device that performs the update-related processing on the network configuration information. Accordingly, even if the on-vehicle relay device 2 includes more than one in-vehicle communication units 23 used for communicating with the external device, the control unit 20 which is executing the update processing program 2g can reliably specify the in-vehicle communication unit 23 for communicating with the external device that performs the update-related processing by referring to the network configuration information inherited from the control program 2c.

It should be considered that the embodiments disclosed this time are illustrative in all aspects and are not limitative. The scope of the present disclosure is indicated not by the meaning described above but by the claims, and all changes that fall within the meaning equivalent to the claims and the scope are to be embraced.

1. An on-vehicle relay device mounted on a vehicle, comprising:
a plurality of communication units including a first communication unit for communicating with a plurality of on-vehicle ECUs mounted on the vehicle and a second communication unit for communicating with an external device outside the vehicle;
a storage storing a control program for performing relay-related control of communications between the plurality of on-vehicle ECUs, an update processing program for performing update-related processing of the control program, and network configuration information related to the plurality of communication units; and
a control unit selectively executing the control program or the update processing program that are stored in the storage,
wherein
in executing the control program, the control unit specifies a first communication unit to which any one of the plurality of on-vehicle ECUs as a relay destination is connected with reference to the network configuration information stored in the storage, and
in executing the update processing program, the control unit specifies a second communication unit for communicating with the external device which performs update-related processing of the control program with reference to the network configuration information stored in the storage and prohibits communication through communication units other than the specified second communication unit for communicating with the external device.

2. The on-vehicle relay device according to claim 1, wherein
the control unit that is executing the control program writes the network configuration information into a storage area of the storage based on a physical address of the storage, and
the control unit that is executing the update processing program refers to the storage area into which the network configuration information is written based on a physical address of the storage.

3. The on-vehicle relay device according to claim 1, wherein the control unit prohibits communication through communication units other than the specified second communication unit for communicating with the external device by stopping supplying power to the communication unit.

4. The on-vehicle relay device according to claim 1, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units, and
the second communication unit for communicating with the external device that performs update-related processing of the control program is the second communication unit to which the diagnostic device or the out-of-vehicle communication device is connected.

5. The on-vehicle relay device according to claim 1, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units,
the control unit that is executing the control program,
if obtaining update-related information output from the diagnostic device, incorporates in the network configuration information a matter that the second communication unit for communicating with the external device that performs update-related processing of the control program is the second communication unit to which the diagnostic device is connected, and
if obtaining update-related information output from the external server, incorporates in the network configuration information a matter that the second communication unit for communicating with the external device that performs update-related processing of the control program is the second communication unit to which the out-of-vehicle communication device is connected.

6. An information processing method causing a computer to execute processing of:
selectively executing relay-related control of communications between a plurality of on-vehicle ECUs or update-related processing of a program for performing the relay-related control;
specifying, in executing the relay-related control, a communication unit to which any one of the on-vehicle ECUs as a relay destination is connected with reference to network configuration information stored in a storage;
specifying, in executing the update-related processing, a communication unit for communicating with an external device that performs update-related processing with reference to network configuration information stored in the storage; and
prohibiting communication through a communication unit other than the communication unit specified.

7. A program causing a computer to execute processing of:
selectively executing relay-related control of communications between a plurality of on-vehicle ECUs or update-related processing of a program for performing the relay-related control;
specifying, in executing the relay-related control, a communication unit to which any one of the on-vehicle ECUs as a relay destination is connected with reference to network configuration information stored in a storage;
specifying, in executing the update-related processing, a communication unit for communicating with an external device that performs update-related processing with reference to network configuration information stored in the storage; and
prohibiting communication through a communication unit other than the communication unit specified.

8. The on-vehicle relay device according to claim 2, wherein the control unit prohibits communication through communication units other than the specified second communication unit for communicating with the external device by stopping supplying power to the communication unit.

9. The on-vehicle relay device according to claim 2, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units, and
the second communication unit for communicating with the external device that performs update-related processing of the control program is the second communication unit to which the diagnostic device or the out-of-vehicle communication device is connected.

10. The on-vehicle relay device according to claim 3, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units, and
the second communication unit for communicating with the external device that performs update-related processing of the control program is the second communication unit to which the diagnostic device or the out-of-vehicle communication device is connected.

11. The on-vehicle relay device according to claim 2, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units,
the control unit that is executing the control program,
if obtaining update-related information output from the diagnostic device, incorporates in the network configuration information a matter that the second communication unit for communicating with the external device that performs update-related processing of the control program is the second communication unit to which the diagnostic device is connected, and
if obtaining update-related information output from the external server, incorporates in the network configuration information a matter that the second communication unit for communicating with the external device that performs update-related processing of the control program is the second communication unit to which the out-of-vehicle communication device is connected.

12. The on-vehicle relay device according to claim 2, wherein the external device outside the vehicle includes a diagnostic device connected to the second communication unit and an external server making communication via an out-of-vehicle communication device connected to the second communication unit,
the network configuration information includes information in which identifiers for identifying the plurality of communication units are associated with information for making classification among the on-vehicle ECUs, the out-of-vehicle communication device and the diagnostic device that are connected to the plurality of communication units,
the control unit that is executing the control program,
if obtaining update-related information output from the diagnostic device, incorporates in the network configuration information a matter that the second communication unit for communicating with the external device that performs update-related processing of the control program is the second communication unit to which the diagnostic device is connected, and
if obtaining update-related information output from the external server, incorporates in the network configuration information a matter that the second communication unit for communicating with the external device that performs update-related processing of the control program is the second communication unit to which the out-of-vehicle communication device is connected.
